(19) United States
(12) Patent Application Publication
(10) Pub. No.: US 2019/0163777 A1
(43) Pub. Date: May 30, 2019

(54) ENFORCEMENT OF GOVERNANCE POLICIES THROUGH AUTOMATIC DETECTION OF PROFILE REFRESH AND CONFIDENCE

(71) Applicant: International Business Machines Corporation, Armonk, NY (US)

(72) Inventors: Manish A. Bhide, SeriLingamaplly (IN); Jonathan Limburn, Southampton (GB); William B. Lobig, Trabuco Canyon, CA (US); Paul S. Taylor, Redwood City, CA (US)

(21) Appl. No.: 15/822,179

(22) Filed: Nov. 26, 2017

(51) Int. Cl. G06F 17/30; G06F 11/34

(52) U.S. Cl. CPC G06F 17/30371; G06F 17/30525; G06F 11/3476; G06F 17/30082

(57) ABSTRACT

Methods and apparatus, including computer program products, implementing and using techniques for enforcing governance policies. In response to comparing an estimated confidence and a confidence boundary for data in a data source, a data governance policy for the data source is enforced by re-profiling the data source.

### BACKGROUND

The present invention relates to data governance, and more specifically, to enforcement of data governance policies. Data governance is a defined process that an organization follows in order to ensure that high quality data exists throughout the complete lifecycle of the data. The key focus areas of data governance include availability, usability, integrity and security. This includes establishing processes to ensure that important data assets are formally managed throughout an enterprise, and that the data can be trusted for decision-making.

A key part of data governance has to do with enforcing data governance policies. Data governance polices are defined using what is typically referred to as “governance rules,” which are based on a data profile. The data profile includes elements such as the data class of each column, the data type, and so on. Some examples of data classes include Social security numbers (SSN), Credit card numbers, date of birth, and so on.

For example, a data governance policy may state:
“If a data asset contains a column whose data classification is a social security number with a confidence of at least 75%, then all access to that column should be logged.”

The confidence of a data classification refers to what percentage of the data in the column belongs to that data class. Expressed differently, the above rule states that if at least 75% of the data in the column is of type SSN, then all access to that data asset should be logged.

A data asset is used to represent data. Examples of data assets include a table in a relational database, a file in object storage, or a database which stores JavaScript Object Notation (JSON) data, such as a Cloudant® database, which is available from International Business Machines Corporation of Armonk, N.Y. A data source can be a relational database or object storage, which contains multiple data assets. A catalog is a metadata repository, which stores information about all data assets. Typically whenever a data asset is added to the catalog, the data asset is profiled. As part of the profiling process, the data class is identified for each column. The data asset that is added to the catalog can be, for example, a database or a file in an external system. Hence these data sources will keep getting updated, and as a result, the data profile of these data sources will change. Therefore, it is important to detect what kind of changes have occurred in the data source and, based on the governance rules, determine whether the data should be re-profiled, and determine the confidence for the data profile after re-profiling.

### SUMMARY

According to one embodiment of the present invention, methods, systems and computer program products are provided for enforcing governance policies. In response to comparing an estimated confidence and a confidence boundary for data in a data source, a data governance policy for the data source is enforced by re-profiling the data source.

The details of one or more embodiments of the invention are set forth in the accompanying drawings and the description below. Other features and advantages of the invention will be apparent from the description and drawings, and from the claims.

### BRIEF DESCRIPTION OF THE DRAWINGS

FIG. 1 shows a method for determining whether a data source should be re-profiled, in accordance with one embodiment.

FIG. 2 shows a more detailed view of step 106, and in particular how insert queries are processed

FIG. 3 shows a more detailed view of step 106, and in particular how delete queries are processed

FIG. 4 shows a block diagram of a re-profiling system, in accordance with one embodiment.

Like reference symbols in the various drawings indicate like elements.

### DETAILED DESCRIPTION

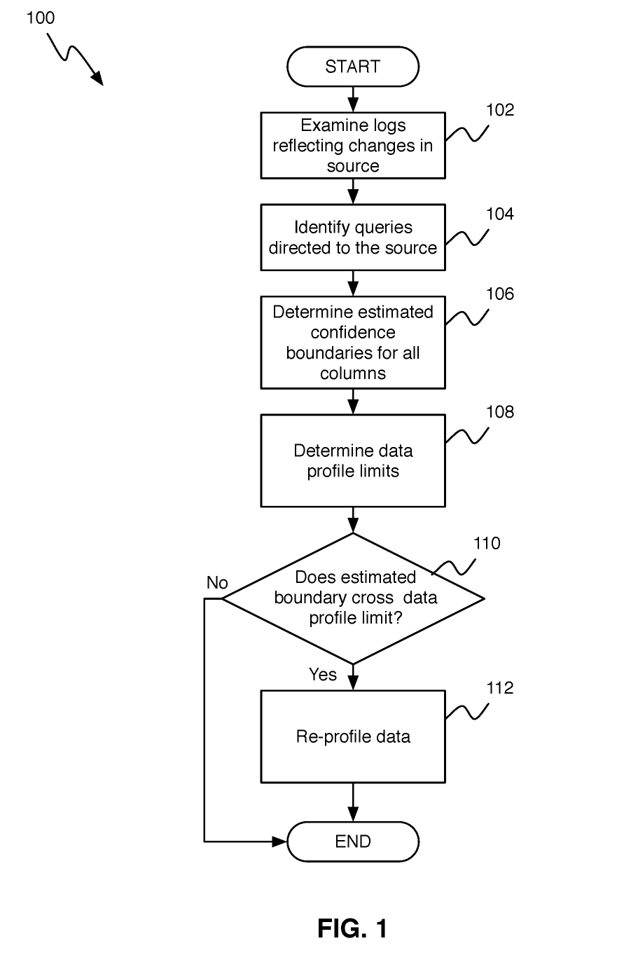

As mentioned above, the data profile of a data source can change over time. Hence it is important to have intelligent techniques for detecting whether a data source should be re-profiled. The various embodiments of the invention described herein pertain to techniques for detecting whether a data source needs to be re-profiled, based on the changes that have occurred in the data source. Techniques for specifying the confidence in a data profile are also provided. A method for detecting whether a data source should be re-profiled, in accordance with one embodiment, will now be described by way of example and with reference to FIGS. 1-4.

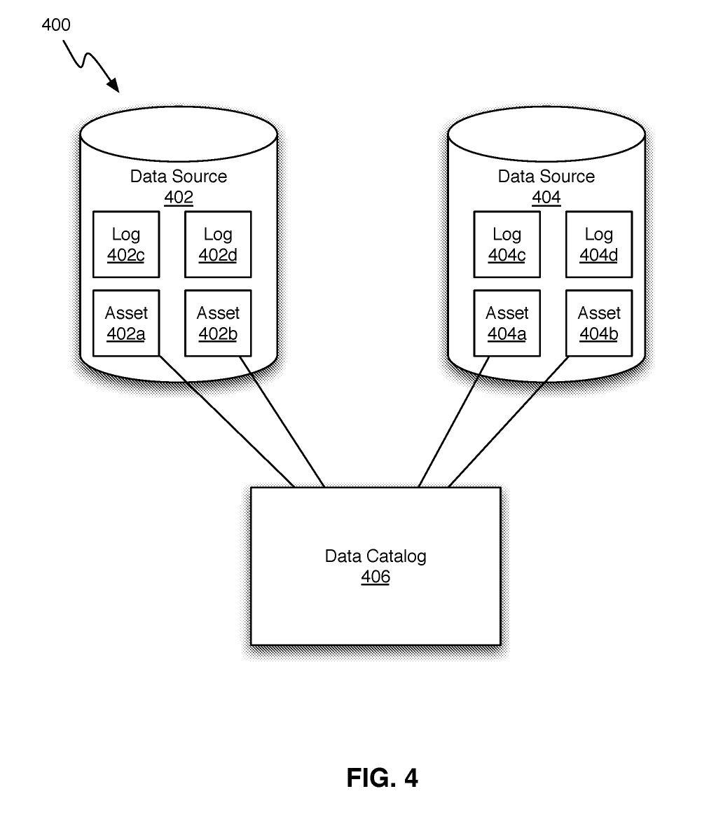

FIG. 4 shows a block diagram of a re-profiling system 400, in accordance with one embodiment, with reference to which the re-profiling process will be described. The re-profiling system 400 includes two data sources, 402 and 404, respectively. As the skilled person realizes, typically a re-profiling system may include many more data sources, and the two data sources shown in FIG. 4 are only shown for purposes of illustration.

Each data source includes a number of assets, illustrated in FIG. 4 with reference numerals 402a, 402b, 404a and 404b, respectively. Also here it should be clear that there are typically many more assets in a data source and that the two data assets shown in FIG. 4 for each data source are only shown for purposes of illustration. In the following, for purposes of explanation, it is assumed that one of the assets, for example, asset 402a is a database table in a relational database.

Each data source includes a number of logs, illustrated in FIG. 4 with reference numerals 402c, 402d, 404c and 404d, respectively. The logs 402c, 402d, 404c, 404d, contain information about operations that have been carried out on the data sources 402, 404, for example, how many records were added, deleted, etc. Also here it should be clear that there are typically many more logs in a data source and that the two logs shown in FIG. 4 for each data source 402, 404, are only shown for purposes of illustration.

The system 400 further includes a data catalog 406, which contains metadata about the data assets 402a, 402b, 404a and 404b, respectively. The metadata can include, for example, data about when the data asset was added to the data source, the profile of the data asset, etc. For example, if a data asset contains five columns, the metadata would include information about the data class and the confidence for each column, such as “Column1 has the SSN data class with 75% confidence.”

Turning now to FIG. 1, the method 100 starts by examining the logs of the data source 402 to determine the set of changes that are occurring in the data source 402, step 102. In one embodiment, the logs 402c, 402d, are kept in the data source 402 itself and not copied to the data catalog 406. The logs 402c, 402d, are fetched from the data source 402 are examined to extract relevant information, such as how many records were added to the data source 402, how many were deleted, etc. The format in which the logs are kept typically differs depending on the type of data source 402. For example, for a database the logs 402c, 402d, will in be one format, and for an object store, the logs 402c, 402d, will be in another format. The format of the logs can also change from one database vendor to another. Tracking the changes for the data source 402 can be done, for example, using a Change Data Capture (CDC) mechanism. In general, CDC can be described as a set of software design patterns used to determine and track the data that has changed, so that an action can be taken using the changed data. Many different versions of CDC mechanisms are familiar to those having ordinary skill in the art.

Next, using the results from the examination of the logs 402c, 402d, a set of insert queries, update queries, and/or delete queries are identified, which are directed to the data source 402, step 104.

The identified queries to the asset 402a, that is, to the database table, and the number of records being touched by the queries are analyzed to determine the estimated confidence boundaries for the different columns in the table, step 106.

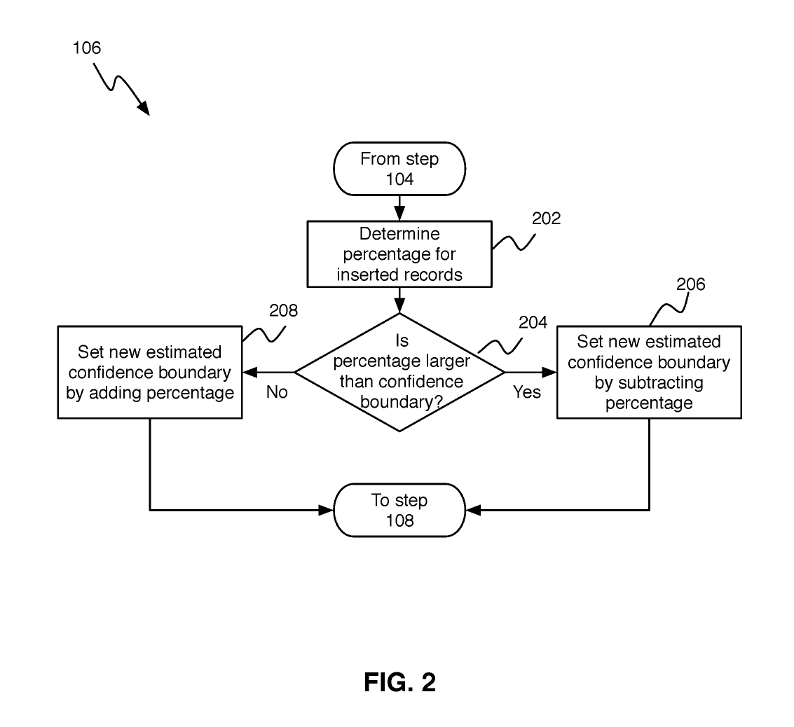

FIG. 2 shows a more detailed view of step 106, and in particular how insert queries are processed. As can be seen in FIG. 2, first the number of records inserted is identified and it is determined what percentage these inserted records constitute with respect to the original number of records that existed at the time of profiling the data step 202. It should be noted that these operations can be done either at column or row level. Even if the operations are conducted at row level, information can be obtained from the transaction logs about the updates that have occurred in each column.

Next, it is determined whether the percentage of inserted records plus the current confidence exceeds the current confidence boundary, step 204. The confidence boundary is determined by a policy. For example, assume a policy states “If a data asset contains a column whose data classification is a SSN with a confidence of at least 75%, then all access to that column should be logged.” Here, the confidence boundary is [75%, >], since at least 75% data should be SSNs for logging access to the column.

If the percentage of inserted records plus the current confidence exceeds the current confidence boundary, a new estimated boundary is set, step 206. In one embodiment, the new estimated boundary is calculated by subtracting the percentage of the inserted records from the current confidence boundary. For example, assume that at the time profiling was done, 90% of the data was SSN. Further, assume that the current confidence boundary is [75%,>] and new data corresponding to 4% of the original data was inserted. The new estimated confidence boundary will then be 86%.

If instead it is determined in step 204 that the percentage of added data is less than the current confidence boundary, the new estimated confidence boundary is set by adding the percentage of inserted data to the confidence boundary, step 208. For example, assume that at the time profiling was done, 0.3% of the data was “Bad Data” for a particular column, and that the policy states “If a data asset contains less than 2% of bad data, then allow access to the data asset” (i.e., the current confidence boundary is [2%,<]). Further assume that new data corresponding to 1% of the original data was inserted. The new estimated confidence boundary will then be 1.3%. The process then proceeds to step 108, which will be described in further detail below.

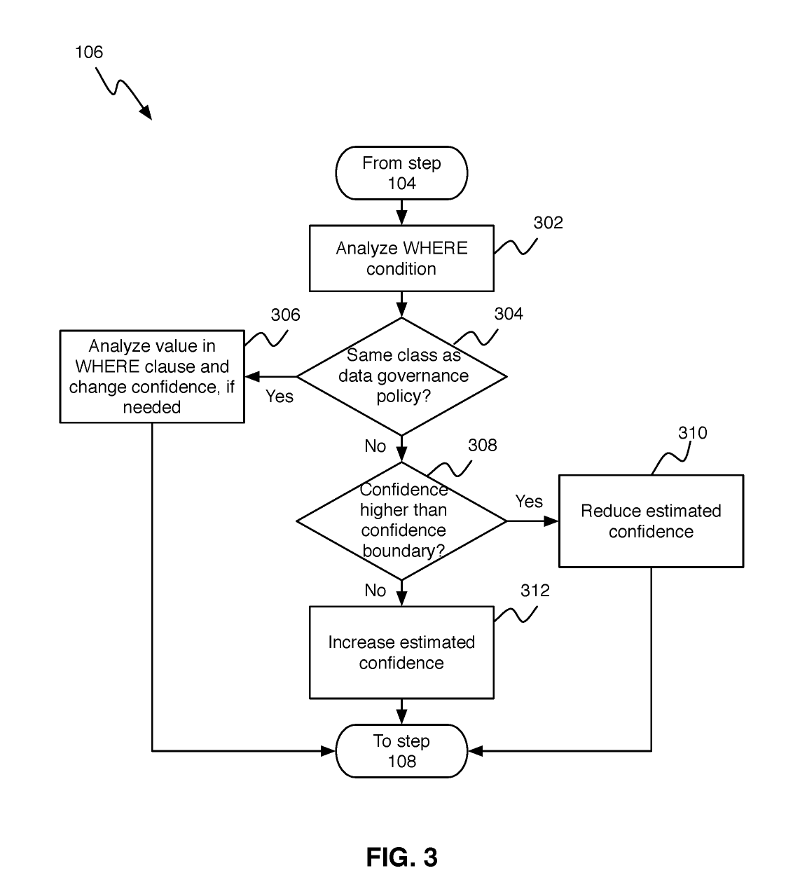

FIG. 3 shows a more detailed view of step 106, and in particular how DELETE queries are processed. As can be seen in FIG. 3, first the WHERE condition is analyzed based on which updates are done, step 302. Next, it is determined whether the WHERE condition is defined on a column having the same class as the class used in the data governance policy, step 304. If the WHERE condition is defined on a column having the same class, then the value used in the WHERE clause is analyzed, step 306. There can be two possible situations:
1) The WHERE clause uses a value that belongs to the class under consideration.
2) The WHERE clause uses a value that does not belong to the class under consideration.

For example, assume the following request is made: “Delete from Ti WHERE SS_Value=‘<some_ssn>’.” If the <some_ssn> is a valid SSN, then the delete operation will reduce the percentage of data in Ti that are of the class SSN. Thus, the estimated confidence will be reduced accordingly. On the other hand, if the <some_ssn> is not a valid SSN, then the estimated confidence will not change.

Returning now to step 304, if it is determined that the WHERE clause is not defined on a column having the same class as the class is used in the data governance policy, it is determined whether the confidence is higher than the confidence boundary for the class, step 308. If the original confidence is higher than the confidence boundary, then the estimated confidence is reduced by the amount of data that is deleted, step 310, and the process returns to step 108, which will be described in further detail below.

For example, assume the data governance policy states: “If a data asset contains a column whose data classification is a social security number with a confidence of at least 75%, then all access to that column should be logged.” Further assume that a data asset contains social security numbers and that 80% of the data is SSN as per the time of profiling. Now if some data is deleted using a column other than SSN, then it is unknown whether the deleted data also included SSNs or not. In this case, the original confidence of 80% is higher than the confidence boundary of 75%. If the deleted data is 4% in size, then the confidence will be reduced by 4% in step 310, and the new confidence will be 76%.

If it is determined in step 308 that the original confidence instead is lower than the confidence boundary, then the new confidence will be estimated by increasing the confidence by the amount of data which was added, step 312, and the process returns to step 108, which will be described below. For example, if the confidence for SSNs at the time of profiling was 70%, and the deleted data was 4% in size as in the previous example, then the new estimated confidence would instead be increased to 74% in step 312.

In the event that the query is an update query, the logic for the WHERE clause will operate as described above for the DELETE query, but with the addition of counting the number of records being updated and changing the estimated confidence boundary accordingly.

Returning now to FIG. 1, next, data profile limits are determined, step 108, by analyzing the data policies. A data profile limit is the confidence boundary that is required by a rule. For example, assume that the rule states “Deny access if at least 75% of the data belongs to SSN”. In this case, the confidence boundary would be [75%, >]. This implies that the data profile limit should be 75% or greater. On the other hand, if a rule states “Log access if the data asset contains at most 2% of bad quality data,” the data profile limit is [2%, <], that is, the confidence boundary should be 2% or less. This is done for every data class, as per the policies defined in the system.

Next, it is examined whether the estimated boundary for at least one data class crosses the data profile limit, step 110. If the estimated confidence boundary crosses the data profile limit, then the data is re-profiled, step 112, which ends the process.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
in response to comparing an estimated confidence and a confidence boundary for data in a data source, enforcing a data governance policy for the data source by re-profiling the data source.

2. The method of claim 1, wherein re-profiling the data source includes:
providing a recommendation to a user to re-profile the data source; and
performing the re-profiling in response to receiving an affirmative response to the recommendation from the user.

3. The method of claim 1, wherein the estimated confidence is determined by tracking data logs for one or more data sources.

4. The method of claim 3, wherein the data logs are data logs for one or more of: create, read, update and delete operations performed on the data source.

5. The method of claim 1, wherein the estimated confidence boundary is based on governance policies and is determined by determining an estimated confidence for each data asset through tracking of data logs for one or more data profiles in the data source.

6. The method of claim 1, wherein re-profiling of the data source occurs in response to detecting that the estimated confidence crosses the confidence boundary.

7. A computer program product comprising a computer readable storage medium having program instructions embodied therewith, wherein the computer readable storage medium is not a transitory signal per se, the program instructions being executable by a processor to perform a method comprising:
in response to comparing an estimated confidence and a confidence boundary for data in a data source, enforcing a data governance policy for the data source by re-profiling the data source.

8. The computer program product of claim 7, wherein re-profiling the data source includes:
providing a recommendation to a user to re-profile the data source; and
performing the re-profiling in response to receiving an affirmative response to the recommendation from the user.

9. The computer program product of claim 7, wherein the estimated confidence is determined by tracking data logs for one or more data sources.

10. The computer program product of claim 9, wherein the data logs are data logs for one or more of: create, read, update and delete operations performed on the data source.

11. The computer program product of claim 7, wherein the estimated confidence boundary is based on governance policies and is determined by determining an estimated confidence for each data asset through tracking of data logs for one or more data profiles in the data source.

12. The computer program product of claim 7, wherein re-profiling of the data source occurs in response to detecting that the estimated confidence crosses the confidence boundary.

13. A re-profiling system, comprising:
one or more data sources, each data source including or more assets and one or more logs containing information about operations that have been carried out on the one or more data sources;
a data catalog containing metadata about the one or more assets;
a processor; and
a memory containing instructions that when executed by the processor causes the processor to enforce a data governance policy for a data source among the one or more data sources by re-profiling the data source, in response to comparing an estimated confidence and a confidence boundary for data in the data source.

14. The system of claim 13, wherein re-profiling the data source includes:
providing a recommendation to a user to re-profile the data source; and
performing the re-profiling in response to receiving an affirmative response to the recommendation from the user.

15. The system of claim 13, wherein the estimated confidence is determined by tracking the data logs for the one or more data sources.

16. The system of claim 15, wherein the data logs are data logs for one or more of: create, read, update and delete operations performed on the data source.

17. The system of claim 13, wherein the estimated confidence boundary is based on governance policies and is determined by determining an estimated confidence for each data asset through tracking of the data logs for one or more data profiles in the data source.

18. The system of claim 13, wherein re-profiling of the data source occurs in response to detecting that the estimated confidence crosses the confidence boundary.
